(19) United States
(12) Patent Application Publication
(10) Pub. No.: US 2013/0251312 A1
(43) Pub. Date: Sep. 26, 2013

(54) OPTICAL FIBER CONNECTOR AND PHOTOELECTRIC TRANSMITTING MODULE INCLUDING SAME

(71) Applicant: I-THUN LIN, Tu-Cheng (TW)

(72) Inventor: I-THUN LIN, Tu-Cheng (TW)

(73) Assignee: HON HAI PRECISION INDUSTRY CO., LTD., Tu-Cheng (TW)

(21) Appl. No.: 13/549,541

(22) Filed: Jul. 16, 2012

(30) Foreign Application Priority Data
Mar. 23, 2012 (TW) 101110013

(51) Int. Cl. G02B 6/36

(52) U.S. Cl. 385/88

(57) ABSTRACT

A photoelectric transmitting module includes an optical fiber connector and a reflector optically coupled to each other. The optical fiber connector includes a main body, an optical fiber, and an adhesive. The main body includes a first surface, a second surface opposite to the first surface, and a third surface connected between the first and second surfaces. The main body defines a fixing groove in the third surface. The fixing groove includes a first inner surface, two second inner surfaces, and a third inner surface. The first inner surface is adjacent to the first surface. The two second inner surfaces extend from the first inner surface to the second surface. The third inner surface is opposite to the third surface. An included angle between each second inner surface and the third inner surface is less than 90 degrees. The adhesive is applied in the fixing groove.

### BACKGROUND

1. Technical Field

The present disclosure relates to optical fiber connectors.

2. Description of Related Art

Optical fiber connector used in photoelectric transmitting module, typically includes a main body and a plurality of optical fibers. The main body includes a fixing groove for receiving the optical fibers. The optical fiber connector further includes cured adhesive for keeping the optical fibers in the fixing groove. However, the cured adhesive easily drops off from the fixing groove.

Therefore, a photoelectric transmitting module and an optical fiber connector which can overcome the above-mentioned problems is needed.

### BRIEF DESCRIPTION OF THE DRAWINGS

FIG. 1 is an isometric and schematic view of a photoelectric transmitting module according to an exemplary embodiment.

FIG. 2 is an exploded view of the photoelectric transmitting module of FIG. 1.

FIG. 3 is similar to FIG. 2, but viewed from another angle.

FIG. 4 is a cross-sectional view taken along line IV-IV of the photoelectric transmitting module of FIG. 1.

FIG. 5 is a cross-sectional view taken along line V-V of the photoelectric transmitting module of FIG. 1.

### DETAILED DESCRIPTION

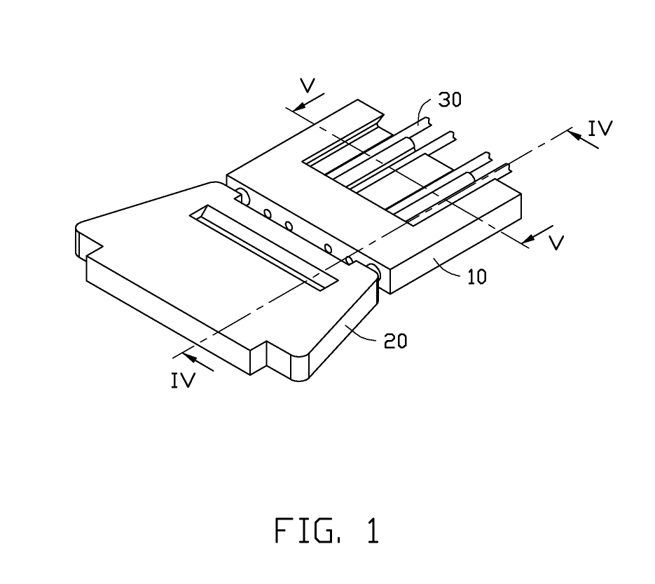

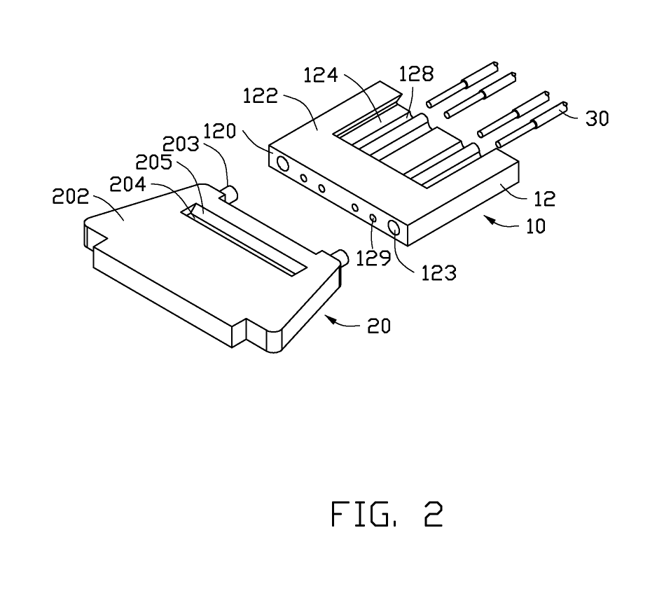

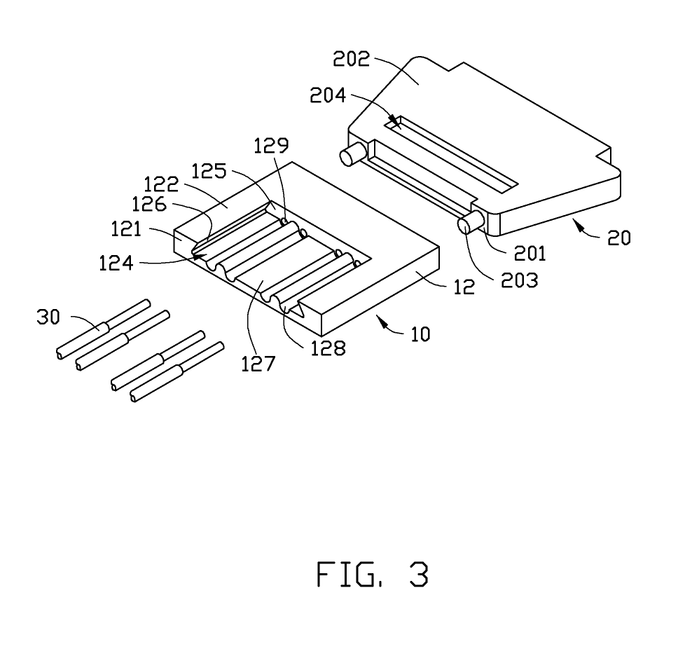

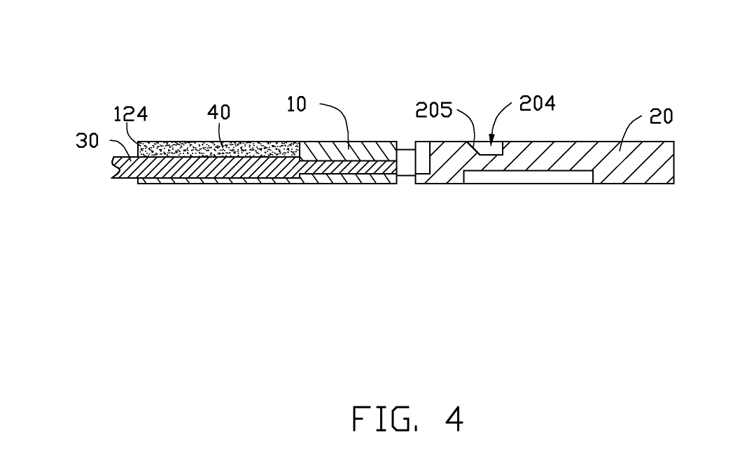

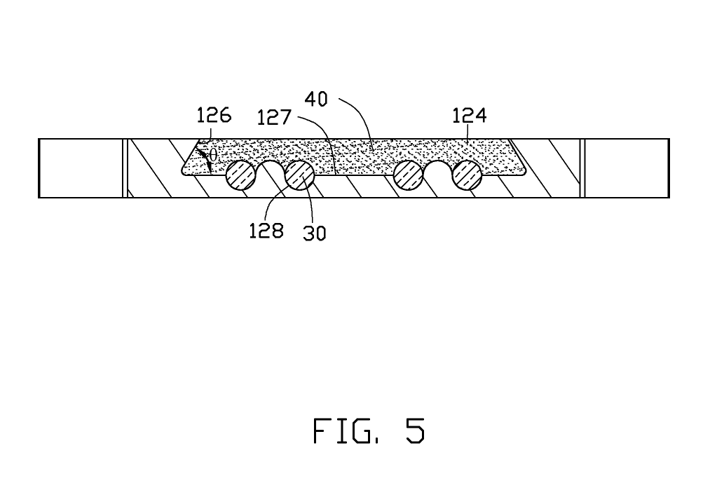

Referring to FIGS. 1 to 5, a photoelectric transmitting module, according to an embodiment, includes an optical fiber connector 10 and a reflector 20 optically coupled to the optical fiber connector 10.

The optical fiber connector 10 includes a main body 12 and a plurality of optical fibers 30. In the embodiment, the number of the optical fibers 30 is four. The main body 12 is substantially a transparent cube. The main body 12 includes a first surface 120 adjacent to the reflector 20, a second surface 121 opposite to the first surface 120, and a third surface 122 connecting the first surface 120 to the second surface 121. The first surface 120 defines two holes 123 at opposite ends of the first surface 120. The main body 12 defines a fixing groove 124 extending from the second surface 121 towards the first surface 120. The fixing groove 124 is a dovetail groove and is open at the third surface 122. The main body 12 further includes a first inner surface 125, two second inner surfaces 126, and a third inner surface 127 for cooperatively form the fixing groove 124. The first inner surface 125 is parallel to the first surface 120. The two second inner surfaces 126 are opposite to each other and perpendicularly extend from the first inner surface 125 to the second surface 121. The third inner surface 127 is parallel to the third surface 122 and is connected to the first inner surface 125 and the second inner surfaces 126. An included angle θ between the second inner surface 126 and the third inner surface 127 is less than 90 degrees.

The third inner surface 127 defines a plurality of receiving grooves 128. The extending direction of the receiving grooves 128 is perpendicular to the first surface 120. In the embodiment, the receiving grooves 128 are half-circular shaped, in other embodiments, the receiving grooves 128 can also be V-shaped. The main body 12 further defines a plurality of receiving holes 129. The receiving holes 129 extend from the first inner surface 125 to the first surface 120. The receiving holes 129 are aligned and communicated with the receiving grooves 128. The receiving grooves 128 and the receiving holes 129 are configured for receiving optical fibers 30.

The reflector 20 is a transparent plate. The reflector 20 includes a fourth surface 201 adjacent to the optical fiber connector 10 and a fifth surface 202 perpendicularly extending from the fourth surface 201. The reflector 20 includes two posts 203 protruding from the fourth surface 201. The posts 203 are configured for being inserted into holes 123, to connect the optical fiber connector 10 to the reflector 20.

The fifth surface 202 defines a reflective groove 204. The reflective groove 204 includes a reflective surface 205. The reflective surface 205 is inclined relative to the fifth surface 202. The reflective surface 205 is coated with reflective material.

When assembling, each of the optical fibers 30 is put in a respective one of the receiving grooves 128. One end of each optical fiber 30 is inserted into the receiving hole 129 and reaches the first surface 120. Curing adhesive 40 is injected into the fixing groove 124 and then is cured. The cured adhesive 40 keeps the optical fibers 30 in the fixing groove. The posts 203 are inserted into the holes 123 to connect the optical fiber connector 10 to the reflector 20.

Because the included angle θ between the second inner surface 126 and the third inner surface 127 is less than 90 degree, the second inner surface 126 can prevent the cured adhesive 40 being dropped from the fixing groove 124, thus to fix the optical fibers 30 in the fixing groove 124 firmly.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A photoelectric transmitting module, comprising:
an optical fiber connector comprising:
a main body comprising a first surface, a second surface opposite to the first surface, and a third surface connected between the first surface and the second surface, the main body defining a fixing groove on the third surface, the fixing groove extending from the second surface towards the first surface and being open at the third surface, the fixing groove comprising a first inner surface, two second inner surfaces, and a third inner surface, the first inner surface being adjacent to the first surface, the two second inner surfaces extending from the first inner surface to the second surface, the third inner surface being opposite to the third surface, an included angle between each of the second inner surfaces and the third inner surface being less than 90 degrees;
an optical fiber received in the fixing groove; and
an adhesive applied in the fixing groove to secure the optical fiber in the main body; and
a reflector optically coupled to the optical fiber connector.

2. The photoelectric transmitting module of claim 1, wherein the third inner surface defines a receiving groove, the main body further defines a receiving hole extending from the first inner surface to the first surface, the receiving hole is aligned and communicated with the receiving groove, the receiving groove and the receiving hole receive the optical fiber.

3. The photoelectric transmitting module of claim 2, wherein the receiving groove is half-circular shaped.

4. The photoelectric transmitting module of claim 1, wherein the first surface defines a hole, the reflector comprises a fourth surface adjacent to the first surface and a post protruding from the fourth surface, the post is inserted into hole.

5. The photoelectric transmitting module of claim 4, wherein the reflector further comprises a fifth surface perpendicularly extending from the fourth surface, the fifth surface defines a reflective groove, the reflective groove comprises a reflective surface, the reflective surface is inclined relative to the fifth surface.

6. The photoelectric transmitting module of claim 5, wherein the reflective surface is coated with reflective material.

7. An optical fiber connector, comprising:
a main body comprising a first surface, a second surface opposite to the first surface, and a third surface connected between the first surface and the second surface, the main body defining a fixing groove, the fixing groove extending from the second surface towards the first surface and being open at the third surface, the fixing groove comprising a first inner surface, two second inner surfaces, and a third inner surface, the first inner surface being adjacent to the first surface, the two second inner surfaces extending from the first inner surface to the second surface, the third inner surface being opposite to the third surface, an included angle between each of the second inner surfaces and the third inner surface being less than 90 degrees;
an optical fiber; and
an adhesive applied in the fixing groove to secure the optical fiber in the main body.

8. The optical fiber connector of claim 7, wherein the third inner surface defines a receiving groove, the main body further defines a receiving hole extending from the first inner surface to the first surface, the receiving hole is aligned and communicated with the receiving groove, the receiving groove and the receiving hole receive the optical fiber.

9. The optical fiber connector of claim 7, wherein the receiving groove is half-circular shaped.
